(19) United States
(12) Patent Application Publication
(10) Pub. No.: US 2022/0335143 A1
(43) Pub. Date: Oct. 20, 2022

(54) SYSTEMS AND METHODS FOR DATA REDACTION

(71) Applicant: Referrd, LLC, Chicago, IL (US)

(72) Inventors: Kian Sarreshteh, Chicago, IL (US); Austin Stretz, Chicago, IL (US)

(21) Appl. No.: 17/234,244

(22) Filed: Apr. 19, 2021

(51) Int. Cl. G06F 21/62

(52) U.S. Cl. CPC G06F 21/6218; G06N 20/00

(57) ABSTRACT

A data redaction system may include one or more processing devices and one or more memory devices in communication with the one or more processing devices. The one or more memory devices may store computer program instructions executable by the one or more processing devices. Data indicating sensitive information may be received. The sensitive information may be identified using a data recognition model. Access data corresponding to access permission for the sensitive information may be determined. Request data may be received corresponding to a request for the data. It may be determined whether the request data indicates a user that is also indicated by the access data. In response to the access data indicating the user, the data may be output. In response to the access data not indicating the user, the data may be output with the sensitive information redacted.

### BACKGROUND

Digital data has proliferated with the ubiquity of computer systems and networks. Digital data may be stored and shared. In some cases, such data may contain information that is intended for and/or restricted to a specific audience. The information may be protected using various security and/or privacy systems. For example, the information may be stored behind a firewall. A device and/or application may access the protected information by conforming to various security criteria established by the firewall. As another example, the information may be protected by a tokenization or encryption protocol. A device and/or application may access the protected information by using a tokenization system or encryption key. As yet another example, the information may be associated with an authentication and/or authorization protocol. A device and/or application may access the information by providing credentials recognized by the authentication and/or authorization protocol. Despite the variety of data security and privacy options, there are various data constructs for which the current state of the art does not provide useful or convenient data protection.

### BRIEF DESCRIPTION OF THE DRAWINGS

The present description will be understood more fully when viewed in conjunction with the accompanying drawings of various examples of systems and methods for data redaction. The description is not meant to limit the systems and methods for data redaction to the specific examples. Rather, the specific examples depicted and described are provided for explanation and understanding of systems and methods for data redaction. Throughout the description the drawings may be referred to as drawings, figures, and/or FIGs.

FIG. 1 illustrates a data redaction system, according to an embodiment.

FIG. 2 illustrates a device schematic for various devices used in the data redaction system, according to an embodiment.

FIG. 3 illustrates a first graphical user interface for uploading data that includes sensitive information, according to an embodiment.

FIG. 4 illustrates a second graphical user interface for displaying an original version of data that includes sensitive information and generating a redacted version of the data, according to an embodiment.

FIG. 5 illustrates a third graphical user interface for toggling between an original version of data and a redacted version, according to an embodiment.

FIG. 6 illustrates a fourth graphical user interface where a user can request a redacted version of data or request access to an original version of the data, according to an embodiment.

FIG. 7 illustrates a fifth graphical user interface where a user can view a redacted version of data or request access to an original version of the data, according to an embodiment.

FIG. 8 illustrates a method of determining an output based on a request for data that includes sensitive information, according to an embodiment.

FIG. 9 illustrates a method of determining an output based on whether requested data includes sensitive information that is restricted, according to an embodiment.

FIG. 10 illustrates a method of identifying sensitive information in data and replacing the sensitive information with placeholder information, according to an embodiment.

FIG. 11 illustrates a method of determining the accuracy of placeholder information generated for sensitive information in received data, according to an embodiment.

FIG. 12 illustrates a method of determining an output based on whether a user is explicitly prohibited from accessing requested data, according to an embodiment.

FIG. 13 illustrates a method of granting permission to view sensitive information in requested data, according to an embodiment.

FIG. 14 illustrates a method of granting permission to view sensitive information in requested data based on various conditions, according to an embodiment.

### DETAILED DESCRIPTION

Systems and methods for data redaction as disclosed herein will become better understood through a review of the following detailed description in conjunction with the figures. The detailed description and figures provide merely examples of the various embodiments of systems and methods for data redaction. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

A conventional data security or privacy system may include an application firewall. The application firewall may be implemented on an application server to inspect incoming requests. The application firewall may protect against certain known vulnerabilities, such as a structured query language (SQL) injection, cookie tampering, and/or cross-scripting. The application firewall may also inspect incoming requests for authentication and/or authorization data such as a valid session identifier (ID).

A conventional data security or privacy system may include a tokenization and/or encryption system. A tokenization system may receive sensitive data, generate a data token for the sensitive data, and store the sensitive data in association with the data token. Upon receiving the data token, the tokenization system may output the sensitive data to a requesting device. Similarly, an encryption system may use an encryption key to create a data cipher for sensitive data. A device or application programmed with the encryption key may decrypt the data cipher to obtain the sensitive data.

A conventional data security or privacy system may include an authentication and/or authorization protocol. A server may establish a session associated with a client. The session may be established based on user credentials such as login information. The server may inspect client requests for a valid and/or active session ID. In response to identifying an appropriate session ID in a request, the server may send requested data to the requesting client.

Unfortunately, conventional data security and privacy systems fail to provide more granular data protection, such as for sensitive data within an individual data file that defines both sensitive and non-sensitive information. Using a conventional system, access to the individual data file is binary. Requests that are not associated with a specific key, recognized token, or recognized credential are rejected. Requests that include a recognized data security element are granted. However, in many industries, such security protocols are overkill when applied to specific data, and result in excessive network traffic and processing bandwidth. For example, an individual document may include predominantly non-sensitive data with just a few words that are sensitive. Much like using ten miles of fence for ten feet of property line, using a conventional security protocol for just a few words of a document expends valuable network and computing resources that could otherwise be conserved or used elsewhere. This is especially true when the individual document is already subject to various security protocols.

Implementations of systems and methods for data redaction described below may address some or all of the problems described above. A data redaction system may include one or more processing devices and one or more memory devices in communication with the one or more processing devices. The one or more memory devices may store computer program instructions executable by the one or more processing devices. The computer program instructions may include receiving, from a first client device, first data that indicates sensitive information. The sensitive information may be identified using a data recognition model trained to identify the sensitive information. The computer program instructions may include determining access data corresponding to access permission for the sensitive information. The computer program instructions may include receiving, from a second client device, request data corresponding to a request for the first data. The computer program instructions may include determining whether the request data indicates a user that is also indicated by the access data. In response to the access data indicating the user, the first data may be output to the second client device. In response to the access data not indicating the user, second data may be output to the second client device that corresponds to the first data with the sensitive data redacted.

The systems and methods for data redaction described herein may provide a granular solution to data security and/or privacy. Specific data within a data file may be targeted for protection. This may reduce overall network traffic and/or increase available processing bandwidth. Where a conventional data security system that receives a request for sensitive data may involve creating a new session ID, redirecting a client to an authentication page, or simply rejecting the request, the data redaction system satisfies the request or provides specific details on what information is sensitive. In a conventional data security system, an unauthenticated and/or unauthorized client may be redirected to several different data locations irrelevant to the requested data before the client may access the requested data. In contrast, the data redaction system outputs the requested information immediately and, when the client is unauthenticated and/or unauthorized, provides details on what specific information in the requested data is sensitive.

Additionally, the systems and methods for data redaction described herein may provide a graphical user interface that enables display of precisely how the sensitive information in an individual data file is protected. The sensitive information may be displayed in the context of the non-sensitive information of the data file. The graphical user interface may enable a data owner to view a redacted version of the data file side-by-side with the original version of the data file, or to toggle between the redacted version and the original version, to ensure the correct information is redacted. The graphical user interface may enable an unauthorized user requesting the data file to view the non-sensitive information without exposing the sensitive information. The graphical user interface may enable an unauthorized user to request access to the sensitive information directly from the document owner. This may give the document owner better, more granular control over how the sensitive information is shared.

A particular example of an industry that may benefit from the systems and methods for data redaction described herein may be the job recruitment industry. A recruiter may have an open position for which the recruiter does not have a candidate, or a candidate for which the recruiter does not have an open position. Historically, while another recruiter may have an open position and/or candidate that matches what the first recruiter is searching for, various incentives of the recruitment industry prevent collaboration. For example, the first recruiter may have an open position and the other recruiter may have a matching candidate. The first recruiter is disincentivized from sharing specific information about the open position, such as the company name and/or the in-house recruiting manager's name, because the other recruiter could bypass the first recruiter and take the entire commission for placing the candidate in the open position.

However, the systems and methods for data redaction described herein enable recruiters to share specific recruitment information and establish agreements for providing sensitive information in the recruitment information. The data redaction system enables recruiters to build trust by redacting the most sensitive information about a candidate or position while still providing sufficient detail to know whether the candidate or position is relevant, thereby establishing firm grounds for trust and cooperation.

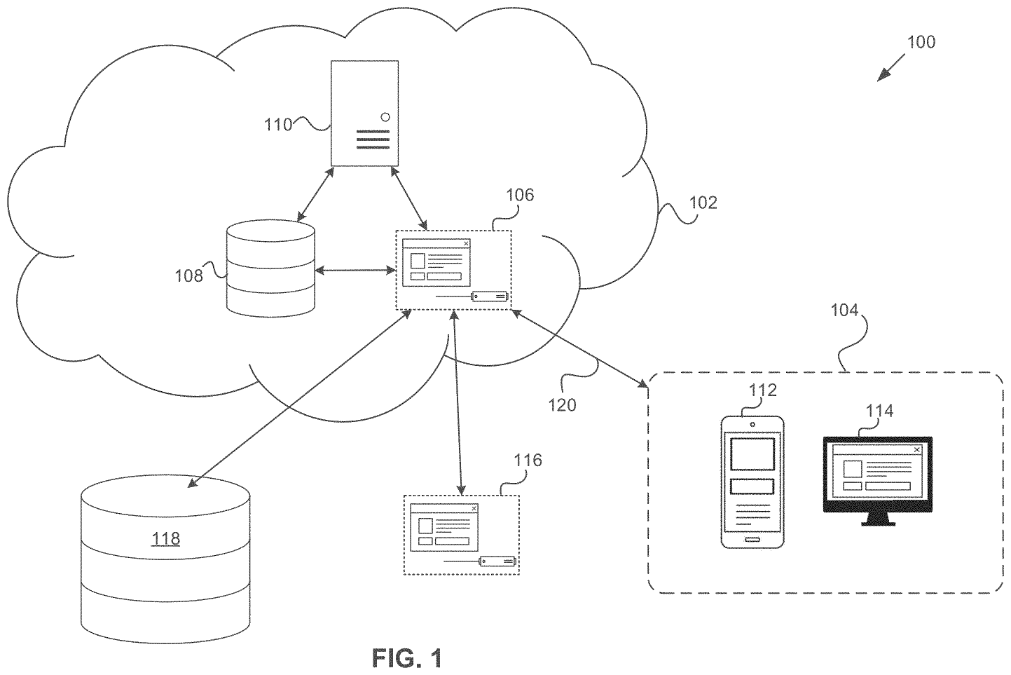

FIG. 1 illustrates a data redaction system 100, according to an embodiment. The data redaction system may provide granular control for data that includes sensitive information and non-sensitive information. By enabling granular data control, the data redaction system 100 may result in reduced network traffic and/or increased processing bandwidth when handling data files that include relatively few sensitive data elements.

The data redaction system 100 may include a cloud-based data management system 102 and a user device 104. The cloud-based data management system 102 may include an application server 106, a database 108, and a data server 110. The user device 104 may include one or more devices associated with user profiles of the data redaction system 100, such as a smartphone 112 and/or a personal computer 114. The data redaction system 100 may include external resources such as an external application server 116 and/or an external database 118. The various elements of the data redaction system 100 may communicate via various communication links 120. An external resource may generally be considered a data resource owned and/or operated by an entity other than an entity that utilizes the cloud-based data management system 102 and/or the user device 104.

The communication links 120 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 120, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 120, may refer to any of the aforementioned indirect communication links.

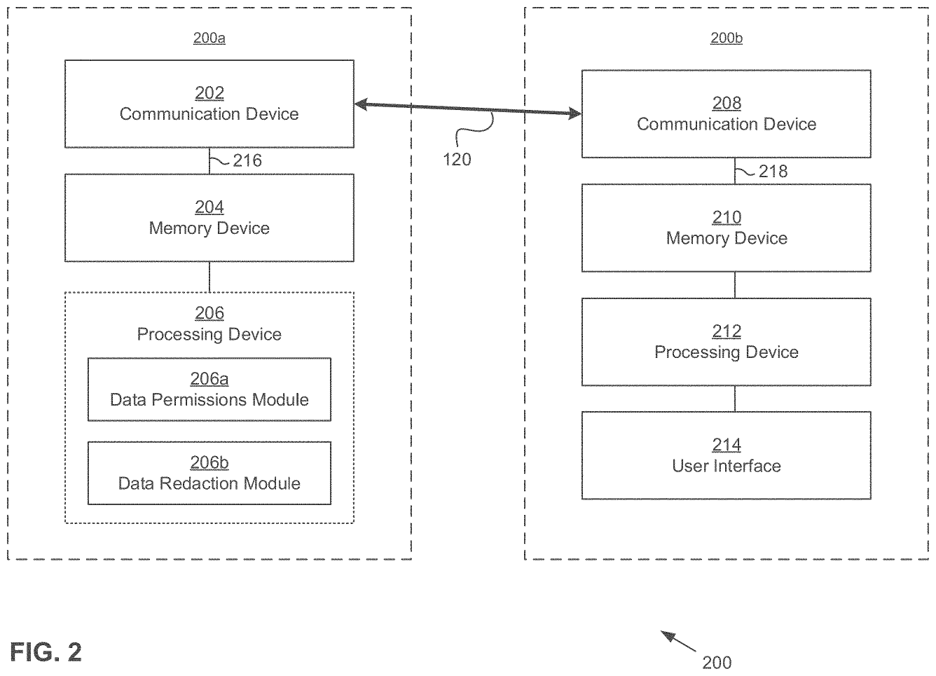

FIG. 2 illustrates a device schematic 200 for various devices used in the data redaction system 100, according to an embodiment. A server device 200a may identify and/or redact sensitive information in a data file to enable sharing of the data file with untrusted entities. The data file may be shared with the untrusted entities showing the full context of the sensitive information without revealing the sensitive information. This may help establish trust between the entities so that the sensitive information can be shared.

The server device 200a may include a communication device 202, a memory device 204, and a processing device 206. The processing device 206 may include a data permissions module 206a and a data redaction module 206b, where module refers to specific programming that governs how data is handled by the processing device 206. The client device 200b may include a communication device 208, a memory device 210, a processing device 212, and a user interface 214. Various hardware elements within the server device 200a may be interconnected via a system bus 216. Similarly, various hardware elements within the client device 200b may be interconnected via a separate system bus 218. The system bus 216 and/or 218 may be and/or include a control bus, a data bus, an address bus, and so forth. The communication device 202 of the server device 200a may communicate with the communication device 208 of the client device 200b.

The data permissions module 206a may handle inputs from the client device 200a. The data permissions module 206a may identify various credentials associated with a request from the client device 200b. When credentials associated with the request match credentials associated with the requested data, the data permissions module 206a may retrieve the data from the memory device 204 for output to the client device 200a. When the credentials do not match or are not present, the data redaction module 206b may cause a redacted version of the requested data to be output to the client device 200b. The data redaction module 206b may generate a redacted version of the data in response to receiving the data from the client device 200b. The data redaction module 206b may designate data received from the client device 200b as a redacted version of other data received from the client device 200b. The data redaction module 206b may identify sensitive information in data received from the client device 200b. For example, the data redaction module 206b may process the data using a data recognition model that is trained to identify sensitive information in the data.

The server device 200a may be representative of the cloud-based data management system 102. The server device 200a may be representative of the application server 106. The server device 200a may be representative of the data server 110. The server device 200a may be representative of the external application server 116. The memory device 204 may be representative of the database 108 and the processing device 206 may be representative of the data server 110. The memory device 204 may be representative of the external database 118 and the processing device 206 may be representative of the external application server 116. For example, the database 108 and/or the external database 118 may be implemented as a block of memory in the memory device 204. The memory device 204 may further store instructions that, when executed by the processing device 206, perform various functions with the data stored in the database 108 and/or the external database 118.

Similarly, the client device 200b may be representative of the user device 104. The client device 200b may be representative of the smartphone 112. The client device 200b may be representative of the personal computer 114. The memory device 210 may store application instructions that, when executed by the processing device 212, cause the client device 200b to perform various functions associated with the instructions, such as receiving user input, processing user input, outputting data and/or data requests, receiving data, processing received data, transmitting data, and so forth.

As stated above, the server device 200a and the client device 200b may be representative of various devices of the data redaction system 100. Various of the elements of the data redaction system 100 may include data storage and/or processing capabilities. Such capabilities may be rendered by various electronics for processing and/or storing electronic signals. One or more of the devices in the data redaction system 100 may include a processing device. For example, the cloud-based data management system 102, the user device 104, the smartphone 112, the personal computer 114, the external application server 116, and/or the external database 118 may include a processing device. One or more of the devices in the data redaction system 100 may include a memory device. For example, the cloud-based data management system 102, the user device 104, the smartphone 112, the personal computer 114, the external application server 116, and/or the external database 118 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the data redaction system 100. Such memory allocation may be based on instructions stored in the memory device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices in the data redaction system 100 may include data communication capabilities. Such capabilities may be rendered by various electronics for transmitting and/or receiving electronic and/or electromagnetic signals. One or more of the devices in the data redaction system 100 may include a communication device, e.g., the communication device 202 and/or the communication device 208. For example, the cloud-based data management system 102, the user device 104, the smartphone 112, the personal computer 114, the external application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the data redaction system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text. A data file may be a set of data elements compiled together such that the data file defines a single data construct, such as a text document, an image, an audio recording, a video recording, and so forth. A data file may include a combination of data constructs that share the same address, or a portion of the same address, in computer memory. Data may be referred to herein as being indicative of information, meaning the data, when viewed by a person or processed by a computer, communicates the information and/or causes the computer to execute instructions associated with the information.

Various of the devices in the data redaction system 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

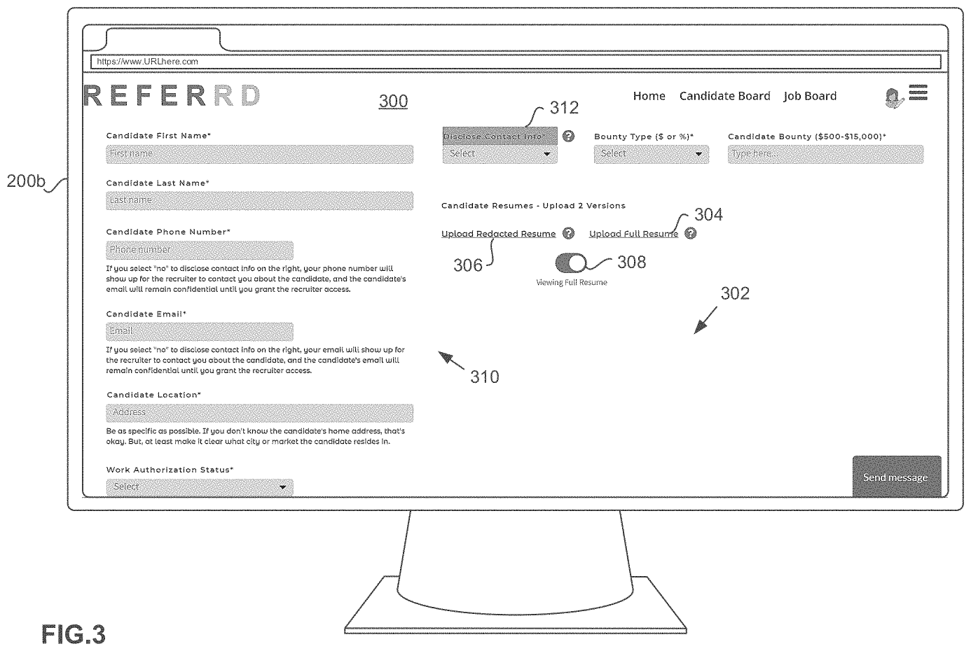

FIG. 3 illustrates a first graphical user interface 300 for uploading data that includes sensitive information, according to an embodiment. The first graphical user interface 300 may be implemented in the data redaction system 100 to enable a server such as the data server 110 to create and/or manage redacted data files such as documents. The first graphical user interface 300 may be generated in the data redaction system 100 by, for example, the data server 110. By having redacted versions of original data, a data owner can precisely control how the data is shared without having to go through other onerous processes such as creating new security rules for a firewall, establishing new user sessions, and so forth.

The first graphical user interface 300 may be generated for display at the client device 200b. For example, the first graphical user interface 300 may be generated for display in a web browser. The first graphical user interface 300 may be defined by a hypertext markup language (HTML). The first graphical user interface 300 may be generated for display by an application running on the client device 200b. The application may be defined by an application programming language such as C, C++, Java™, JavaScript™, Swift™, Objective-C, and so forth.

The first graphical user interface 300 may include a document visualization field 302. The document visualization field 302 may, for example, be implemented as an <img> tag nested in a <div> class. The <img> tag may reference a memory location, such as a uniform resource locator (URL) associated with a data file that indicates sensitive information. Before the data file has been uploaded, the document visualization field 302 may be empty or may have a placeholder that indicates uploaded data will be displayed in the document visualization field 302.

The first graphical user interface 300 may include a first interactable data object 304. An interaction in the first graphical user interface 300 with the first interactable data object 304 may trigger uploading the data file to, for example, the server device 200a, and/or receiving the data file by the server device 200a. For example, the first interactable data object 304 may be associated with instructions for opening a file explorer to identify a current memory location for the data file. The file explorer may be opened as a new display field in the first graphical user interface 300 or as a new window/page on the client device 200b. The current memory location may be on the client device 200b or in a remote database such as the external database 118. When the data file is selected, it may be output to and received by the server device 200a.

The first graphical user interface 300 may include a second interactable data object 306. An interaction in the first graphical user interface 300 with the second interactable data object 306 may trigger uploading the data file to, for example, the server device 200a, and/or receiving a redacted version of the data file by the server device 200a. Additionally or alternatively, an interaction with the second interactable data object 306 may trigger the server device 200a to generate a redacted version of the data file by the data redaction module 206b.

The first graphical user interface 300 may include a variable data object 308. A first state of the variable data object 308 may correspond to the document visualization field 302 being populated with display data corresponding to the original data file. A second state of the variable data object 308 may correspond to the document visualization field 302 being populated with display data corresponding to the redacted version of the data file. When the data file has not been uploaded, the first state may correspond to the document visualization field 302 being empty or being populated using placeholder data. When a redacted version has not been uploaded, or when redaction of an uploaded data file has not been executed and/or completed by the data redaction module 206b, the second state may similarly correspond to the document visualization field 302 being empty or being populated using placeholder data.

The first graphical user interface 300 may include a set of data entry fields 310. The data entry fields 310 may correspond to specifically-requested information regarding a data file to be uploaded via the first graphical user interface 300. For example, the data file may be a resume for a job candidate. The data entry fields 310 may include a field for the candidate's name, contact information, location, work authorization status, and so forth. The first graphical user interface 300 may include a second variable data object 312 corresponding the to the data entry fields 310. A first state of the second variable data object 312 may correspond to the information entered into the data entry fields 310 being hidden when the data file is posted to, for example, a website. A second state of the second variable data object 312 may correspond to the information may be visible.

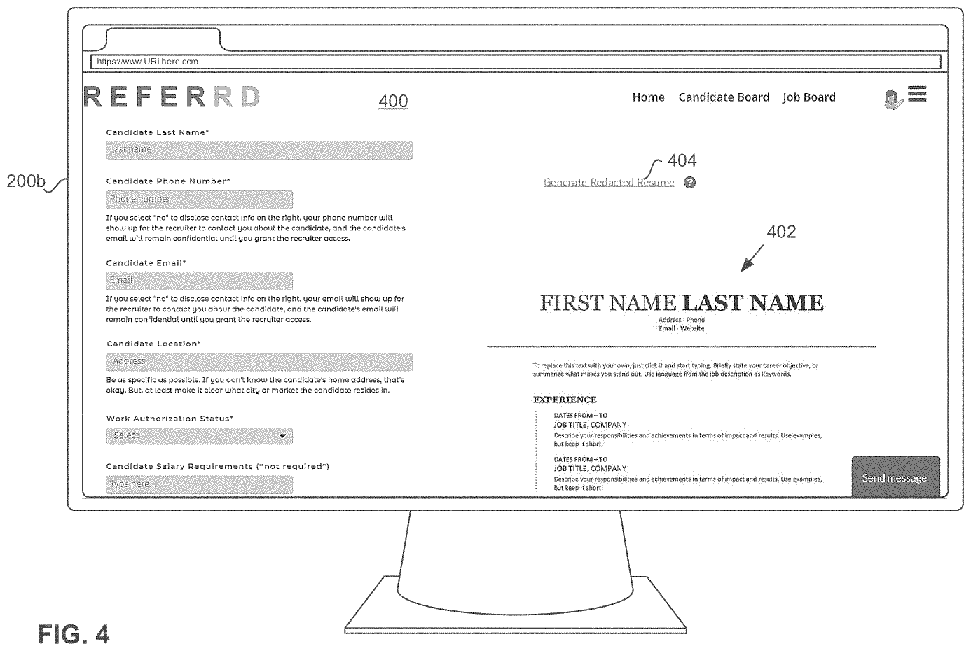

FIG. 4 illustrates a second graphical user interface 400 for displaying an original version of data that includes sensitive information and generating a redacted version of the data, according to an embodiment. The second graphical user interface 400 may be generated in the data redaction system 100 by, for example, the data server 110. The second graphical user interface 400 may enable the server to receive an instruction to automatically redact sensitive information from an uploaded data file and/or to generate a new data file that is a redacted version of the originally-uploaded data file.

The second graphical user interface 400 may be generated for display at the client device 200b similar to the first graphical user interface 300. The second graphical user interface 400 may include a document visualization field 402 similar to the document visualization field 302 of the first graphical user interface 300. The document visualization field 402 may enable display of an uploaded data file in the originally-uploaded format. The second graphical user interface 400 may include an interactable data object 404. The interactable data object 404 may, for example, be a button or a link that, when selected, triggers the data redaction module 206b to scan the original data file and identify sensitive information.

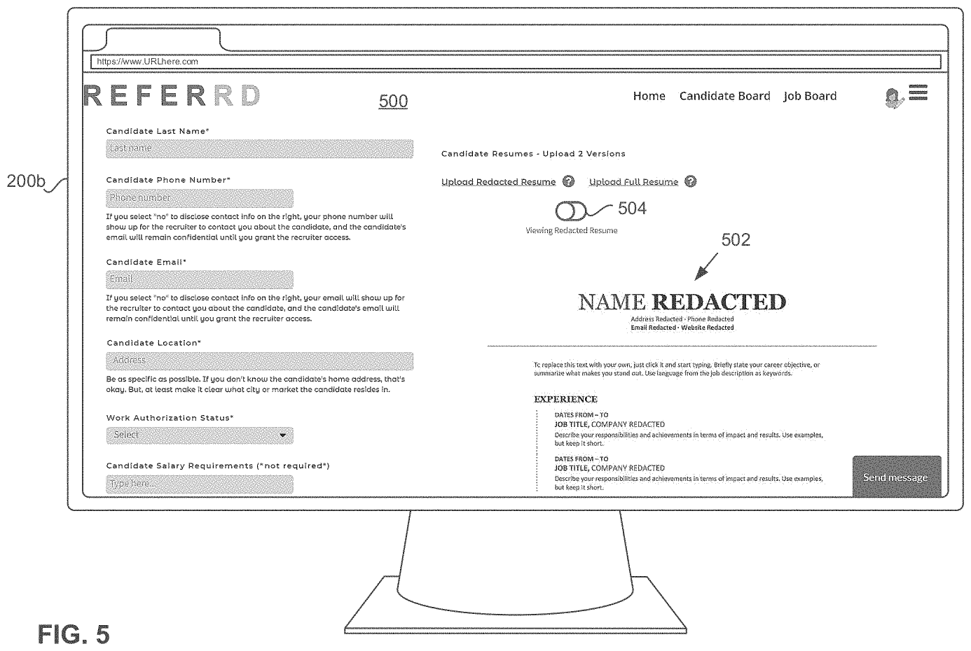

FIG. 5 illustrates a third graphical user interface 500 for toggling between an original version of data and a redacted version, according to an embodiment. The third graphical user interface 500 may be generated in the data redaction system 100 by, for example, the data server 110. The third graphical user interface 500 may enable the data owner to ensure sensitive information was not missed in a redacted version of an uploaded data file that was generated by, for example, the data server 110.

The third graphical user interface 500 may be generated for display at the client device 200b similar to the first graphical user interface 300. The third graphical user interface 500 may include a document visualization field 502 similar to the document visualization field 302 of the first graphical user interface 300. The document visualization field 502 may enable display of a redacted version of an uploaded data file. The third graphical user interface 500 may include a variable data object 504. The variable data object 504 may be a toggle object similar to the variable data object 308 of the first graphical user interface 300. The variable data object 504 may have a first state and a second state. The first state may correspond to the original data file being displayed in the document visualization field 502. The second state may correspond to the redacted version of the data file being displayed in the document visualization field 502.

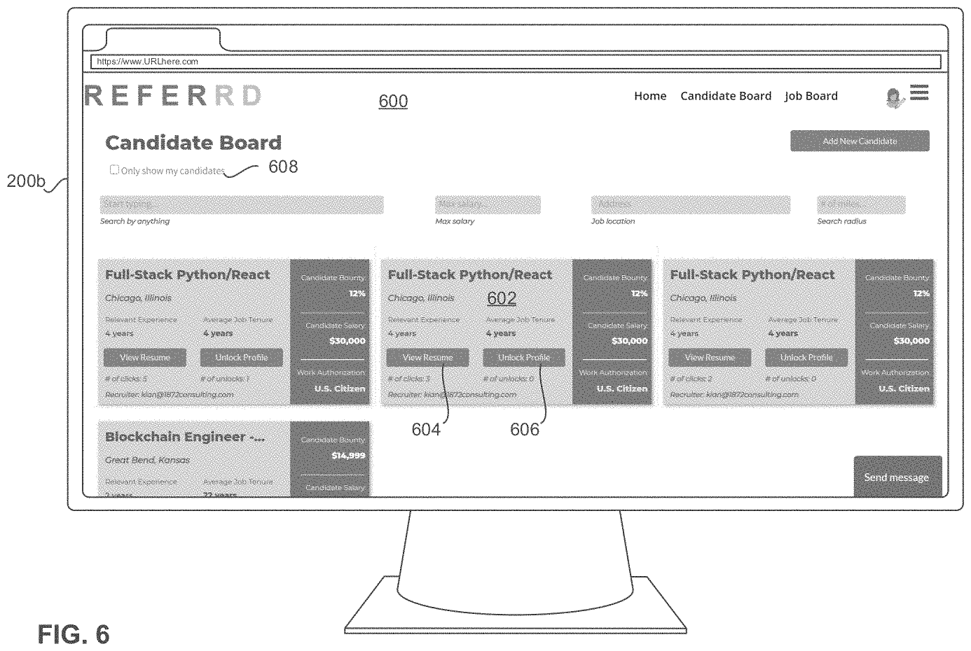

FIG. 6 illustrates a fourth graphical user interface 600 where a user can request a redacted version of data or request access to an original version of the data, according to an embodiment. The fourth graphical user interface 600 may be generated in the data redaction system 100 by, for example, the data server 110. The fourth graphical user interface 600 may enable the server to receive a request from a user for an original data file and/or a redacted version of the data file. This may allow the user to determine whether to request access to the sensitive information.

The fourth graphical user interface 600 may include a data container 602. The data container 602 may include various display elements such as text, images, and/or interactable objects. The data container 602 may display information associated with a data file that includes sensitive information. The data container 602 may display non-sensitive information associated with the data file. The server, such as the data server 110, may extract the non-sensitive information from the data file and format the non-sensitive information according to a display layout of the data container 602. The data container 602 may include a first interactable data object 604 and a second interactable data object 606. An interaction with the first interactable data object 604 may generate a request to the server for a redacted version of the data file. An interaction with the second interactable data object 606 may generate a request to the server for the original version of the data file.

The fourth graphical user interface 600 may include a third interactable data object 608. An interaction with the third interactable data object 608 may automatically update the display of the fourth graphical user interface 600 to include and/or exclude specified information, data objects, variables, fields, and so forth.

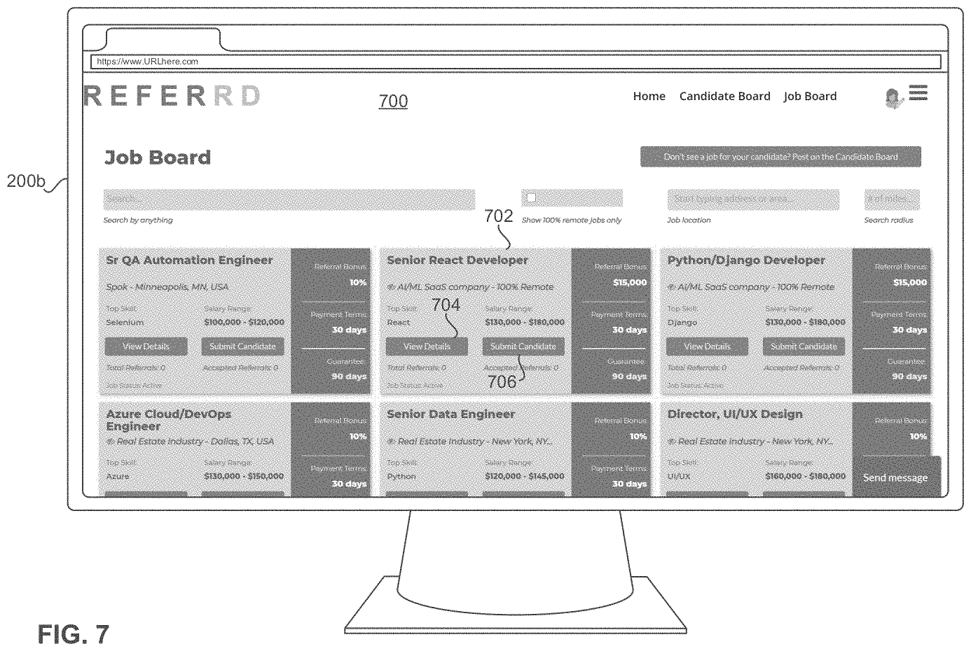

FIG. 7 illustrates a fifth graphical user interface 700 where a user can view a redacted version of data or request access to an original version of the data, according to an embodiment. The fifth graphical user interface 700 may be generated in the data redaction system 100 by, for example, the data server 110. The fifth graphical user interface 700 may enable the server to receive a request to view an original version of a data file. The fifth graphical user interface 700 may also enable a user to determine whether to request access to the sensitive information.

The fifth graphical user interface 700 may include a data container 702. The data container 702 may be similar to the data container 602 of the fourth graphical user interface 600. The data container 702 may display non-sensitive information associated with the data file. The data container 702 may include a first interactable data object 704 and a second interactable data object 706. An interaction with the first interactable data object 704 may generate a request to the server for the original version of the data file. An interaction with the second interactable data object 706 may correspond to initiating an agreement between the user and the data owner based on the sensitive information in the data file.

Various methods are described below that may be implemented in the data redaction system 100 and/or using the various graphical user interfaces described above. In general, one or more memory devices may store instructions corresponding to the below methods. The instructions may be executable by one or more processing devices in communication with the one or more memory devices.

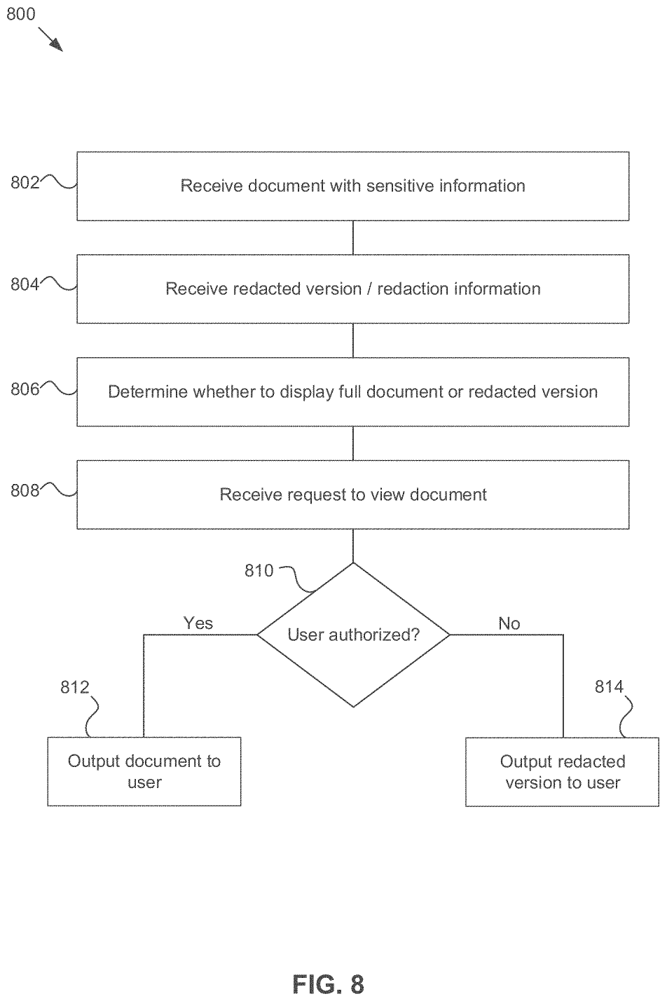

FIG. 8 illustrates a method 800 of determining an output based on a request for data that includes sensitive information, according to an embodiment. A system in which the method 800 is implemented, such as the data redaction system 100, may have reduced network traffic. The method 800 may enable data protection without resorting to more complex processes such as generating new user sessions, integrating a token system, and/or generating encryption keys. Additionally, the method 800 may enable sharing of data that includes sensitive information without exposing the sensitive information.

The method 800 may include receiving data from a first client (block 802). The data may, for example, correspond to a document. The data may define an electronic document. The data may include text data, image data, and/or formatting data for the electronic document. The first client may be a client device such as the smartphone 112 and/or the personal computer 114. The first client may be an instance of a client application running on, for example, the client device 200a. The data may be stored in a database. The data may be indicative of sensitive information that a data owner wants withheld from the view of one or more other individuals and/or entities. As an example, the data may correspond to an electronic document such as a resume. Certain text of the document may communicate a job candidate's name, contact information, schools they attended, and past employers. A recruiter helping the candidate find a new job may want to share the candidate with other recruiters. However, other recruiters could use the candidate's specific information to poach the candidate. Thus, such information may be considered sensitive.

In various implementations, the data may be received from a server and/or database device of a third party. For example, the data may be employment information about a job candidate. The job candidate may have a profile with a networking site such as LinkedIn® where the job candidate's past employment information is included with the job candidate's profile. The data may be retrieved from one or more databases that store the job candidate's employment information. The employment information may be identified in the database based on object, entity, field, and/or attribute information. A natural language processing algorithm may be applied to database entries to identify relevant information.

The method 800 may include receiving, from the first client, redaction data corresponding to redaction of the sensitive information (block 804). The redaction data may be a version of the original data with the sensitive information removed and/or replaced. For example, the original data may define an electronic document that includes the sensitive information and other non-sensitive information. The redaction data may define an electronic document that includes the non-sensitive information. The sensitive information may be deleted and/or replaced with placeholder information. Continuing with the example of the job candidate resume, the original document may include the job candidate's name and contact information, whereas the redacted document may include placeholder information in place of the sensitive information, such as “Name Redacted,” “Phone Number Redacted,” and so forth.

The redaction data may indicate a list or other description of the sensitive information. For example, the data owner may enter the sensitive information into a form via a graphical user interface displayed at a client device. The redaction data may be generated based on entries in the form and received at another device such as a server for processing the redaction data. As another example, the data owner may upload a redaction document that describes the sensitive information without the non-sensitive information.

The method 800 may include determining access data that indicates one or more permissions to access the sensitive information (block 806). The access data may indicate one or more user profiles permitted to access the sensitive information. The access data may be generated in response to receiving the first document data. For example, the data owner may be identified in a system such as the data redaction system 100 by user profile data. The user profile data may be associated with the client from which the original data and/or the redaction data was received. The system may automatically generate access data for the user profile data associated with the client from which the original data is received. The access data may be metadata added to the original document. The access data may be a table in a database that lists usernames for individuals approved by the data owner to access the original data. The access data may be a table in a database that lists names and/or file paths for data a particular user is permitted to access.

The system may automatically generate access data for other users based on the original data, the redaction data, and/or user profile data associated with the client from which the original and/or redaction data was received. For example, the user profile data may be associated with an organization and/or entity that has multiple users of the system. The access data may be generated for other users within the same organization and/or entity as the user that uploaded the original data. As another example, the original data may explicitly indicate users permitted to access the original data.

Determining the access data may include receiving additional user profile data from the client that uploaded the original data other than the user profile data associated with the client. For example, a graphical user interface that enables uploading the original data may include one or more data fields for indicating permitted users. When the original data is uploaded, permitted user data entered into the data fields may also be uploaded and received by the server. The additional user profile data for a permitted user may be received separately from the original data. The additional user profile data for a permitted user may be received from a different client than the client that uploaded the original data. The different client may be associated with the data owner and/or another user in the same organization as the data owner.

The method 800 may include receiving, from a second client, request data corresponding to a request for the original data (block 808). The request data may include individual user data that indicates an individual user requesting access to the original data. The request data may be accompanied by and/or include the access data. The access data received with the request data may indicate an agreement between the data owner and the individual user requesting the data to permit access to the original data. The access data may indicate an executed contract. When additional access data is received, the access data for the original data may be updated.

The method 800 may include determining, based on the individual user data associated with the request to access the original data, whether the access data indicates permission for the individual user to access the sensitive information (block 810). The method 800 may include, in response to the access data indicating permission for the individual user to access the sensitive information, outputting the original data (block 812). The original data may be output to the second client associated with the request. The original data (e.g., an exact replication of the original data) may be output in its original format. The original data may be output in a different format to prevent editing of the original data. For example, the original data may indicate a word processing format. The original data may be output in a portable document format.

The method 800 may include, in response to the access data not indicating permission for the individual user to view the sensitive information, outputting second document data that corresponds to the first document with the sensitive information redacted (block 814). The second document data may be output to the second client device. The second document data may be generated based on the first document data and the redaction data in response to receiving the redaction data and the first document data. The second document data may be generated in response to determining the access data does not indicate permission for the individual user to view the sensitive information. The second document data may be received from the first client device and may include the redaction data.

In various implementations, outputting the first document data or the second document data may include generating a user interface comprising a data field. The user interface may be output to the second client device and/or the first client device. The data field of the user interface may be populated with the first document data or the second document data. The data field of the user interface may be populated with image data based on the first document data or the second document data. The data field of the user interface may be populated with hyperlink data that indicates a uniform resource location for the first document data or the second document data. In various implementations, outputting the first document data or the second document data may include generating message data that is output via a mail server. The mail server may forward the message data to the first client device or the second client device. The message data may include the first document data or the second document data. The message data may include the image data. The message data may include the hyperlink data.

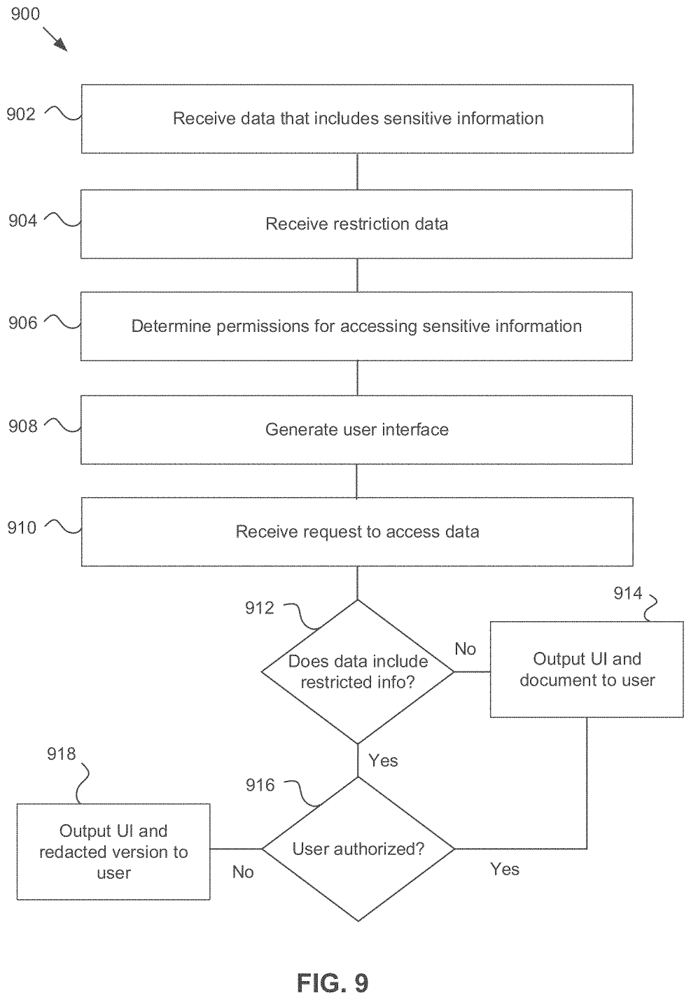

FIG. 9 illustrates a method 900 of determining an output based on whether requested data includes sensitive information that is restricted, according to an embodiment. In various cases, a data owner may or may not want sensitive information restricted from various other users. Various of the systems and/or methods described herein may enable automatic and/or manual identification of the sensitive information. The method 900 further enables determination of whether the sensitive information should be restricted. This may conserve computer resources, such as memory, processing bandwidth, and/or network bandwidth, by determining precisely how the sensitive information should be handled.

The method 900 may include receiving first data that is indicative of sensitive information (block 902). The first data may be received from, for example, a client and/or instance of a client application associated with a data owner (i.e., a first user). The method 900 may include receiving restriction data associated with the sensitive information (block 904). The restriction data may indicate whether the sensitive information should be restricted to being accessed by authorized users. The first data may indicate the restriction data. The restriction data may be received separately from the sensitive information. A first portion of the sensitive information may be restricted, and a second portion may be unrestricted. The restriction data may indicate one or more authorized users authorized to access the sensitive information. The restriction data may indicate one or more unauthorized users that are expressly prohibited from accessing the sensitive information. Second data corresponding to a redacted version of the first data may be generated. The second data may be generated in response to the restriction data indicating at least a portion of the first data should be restricted. The second data may be received from the first user.

The method 900 may include determining access data corresponding to access permission for the sensitive information (block 906). The access data may be based on the presence of the sensitive information. The access data may be based on the first data indicated whether to restrict any portion or all of the sensitive information. The access data may be based on the restriction data. Instructions for determining the access data may be executed in response to receiving the restriction data.

The method 900 may include generating a user interface comprising a data field and a corresponding interactable data object (block 908). The interactable data object may correspond to generating a computer-readable request for the first data. The user interface may be generated as data and/or other computer-readable instructions executable by a client application and/or client device. The data and/or instructions may be output to a client device. The method 900 may include receiving request data corresponding to a request for the first data (block 910). The request data may be received from a client device and/or an instance of a client application associated with a user requesting access to the first data (i.e., a second user). Receiving the request data may correspond to an interaction with the interactable data object in the user interface.

The method 900 may include determining whether the first data is indicative of sensitive information that is restricted to being accessed by authorized users based on the restriction data (block 912). In response to the sensitive information being unrestricted, the method 900 may include outputting the user interface data and the first data to the second user (block 914). The first data may be output to the client device and/or application associated with the second user. The data field of the user interface may be populated with the first data.

In response to at least a portion of the sensitive information being restricted, the method 900 may include determining whether the request data indicates a user that is also indicated by the access data (block 916). In response to the second user being authorized (e.g., being indicated by the access data), the method 900 may include outputting the user interface data and the first data to the second user (block 914). In response to the second user not being authorized (e.g., not being indicated by the access data), the method 900 may include the user interface data and the second data to the second user (block 918). The data field may be populated using the second data. In various implementations where the user interface is already displayed at the client device and/or application associated with the second user, the data field may be updated accordingly to be populated with the first data or the second data depending on the access data.

In various implementations, the request data may be received before the restriction data is received. The system may be programmed to assume that sensitive information is restricted to being accessed by authorized users. In response to receiving the request data before receiving the restriction data, the second data may be output to the client device and/or application associated with the second user. The system may be programmed to assume the sensitive information is not restricted unless otherwise specified by the restriction data. In response to receiving the request data before receiving the restriction data, the unredacted first data may be output to the client device and/or application associated with the second user.

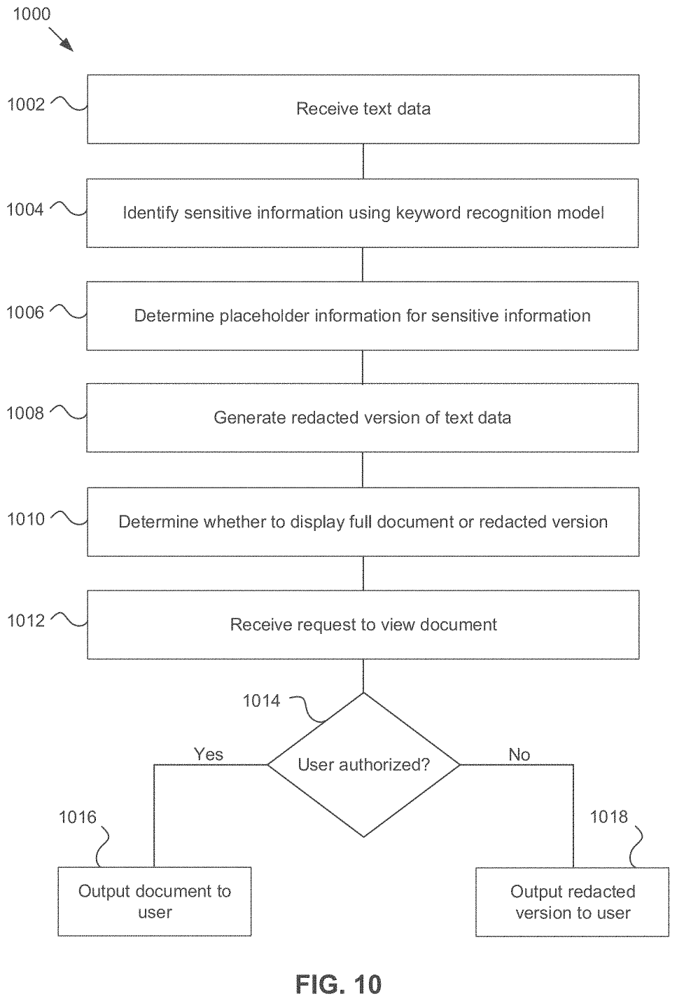

FIG. 10 illustrates a method 1000 of identifying sensitive information in data and replacing the sensitive information with placeholder information, according to an embodiment. In various implementations, a keyword model or other data recognition model may be used to identify the sensitive information automatically. This may conserve network bandwidth by reducing back-and-forth traffic between a server and a client device/application of a data owner. This may increase available memory resources by minimizing the amount of data processed and/or stored relative to, for example, a data owner manually uploading a full version of the data and a redacted version of the data.

The method 1000 may include receiving first text data (block 1002). The first text data may be received from a first client device associated with a data owner (i.e., a first user). The method 1000 may include identifying, using the keyword recognition model, a portion of the first text data indicating sensitive information (block 1004). The keyword recognition model may be based on a supervised, semi-supervised, and/or unsupervised learning algorithm. The keyword recognition model may be and/or include linear regression, logarithmic regression, a decision tree, a random forest of decision trees, a support vector, a Bayesian algorithm, a k-means algorithm that addresses clustering, a dimensionality reduction algorithm, a gradient-boosting algorithm, and so forth. The keyword recognition model may be based on a deep learning algorithm such as an artificial neural network. The keyword recognition model may be based on a reinforcement learning model, a structured prediction model, an anomaly detection model, and so forth.

The keyword recognition model may be trained to recognize a proper noun indicated by the first text data. The sensitive information may include entity name information. The keyword recognition model may be and/or include a named entity recognition model. The keyword recognition model may be trained using named entity data. In a specific implementation, the keyword recognition model may be trained using resume data to identify a candidate name, candidate contact information, a school name, and/or a company name. The keyword recognition model may be trained to identify the sensitive information based on position data that indicates a position of the sensitive information in a document corresponding to the first text data. The keyword recognition model may be trained to identify the sensitive information based on size data that indicates a relative text size associated with the sensitive information. The relative text size may be based on various text sizes associated with the first text data. The keyword recognition model may be trained to identify the sensitive information based on emphasis data that indicates a text emphasis associated with the sensitive information. The keyword recognition model may be trained to identify the sensitive information based on capitalization data that indicates a capitalization associated with the sensitive information.

The method 1000 may include determining placeholder data for the sensitive information indicated in the first text data (block 1006). The placeholder data may correspond to placeholder information for replacing the sensitive information. The placeholder data may be received from the first client device, where determining the placeholder data includes identifying the placeholder data received from the first client device. The placeholder data may be automatically retrieved from a database for placeholder data. The placeholder data may be directly indicated in program code and/or instructions, such as an if-then statement that replaces sensitive information with the text “redacted.” The placeholder data may be identified based on profile data associated with the first client device. For example, the data owner may upload standard placeholder data for use with data uploaded by the data owner.

The method 1000 may include, in response to identifying the sensitive information and/or determining the placeholder data, generating second text data that represents a redacted version of the first text data (block 1008). The second text data may include instructions for outputting the first text data with the sensitive information redacted. The second text data may be a copy of the first text data. The copy may be updated to indicate alternative information instead of the sensitive information.

The method 1000 may include determining access data corresponding to access permission for the sensitive information (block 1010). The method 1000 may include receiving request data corresponding to a request for the first text data (block 1012). The method 1000 may include determining whether the request data indicates a user that is also indicated by the access data (block 1014). The method 1000 may include, in response to the access data indicating the user, outputting the first text data to the requesting device and/or user (block 1016). The method 1000 may include, in response to the access data not indicating the user, outputting the first text data with the placeholder data such that the first text data indicates the placeholder information instead of the sensitive information (block 1018). Additionally or alternatively, the second text data may be output.

While the method 1000 is described regarding a keyword recognition model, it is understood that similar steps may be executed to identify sensitive information in non-text data and/or mixed data. For example, a data recognition model may be implemented to identify sensitive information in images. The sensitive information may, for example, be a person's likeness, information that indicates a location, text in an image, and so forth. The data recognition model may implement various techniques such as facial recognition, optical character recognition, structural feature recognition, and so forth. The data recognition model may be trained using image data, text data, audio data, and so forth.

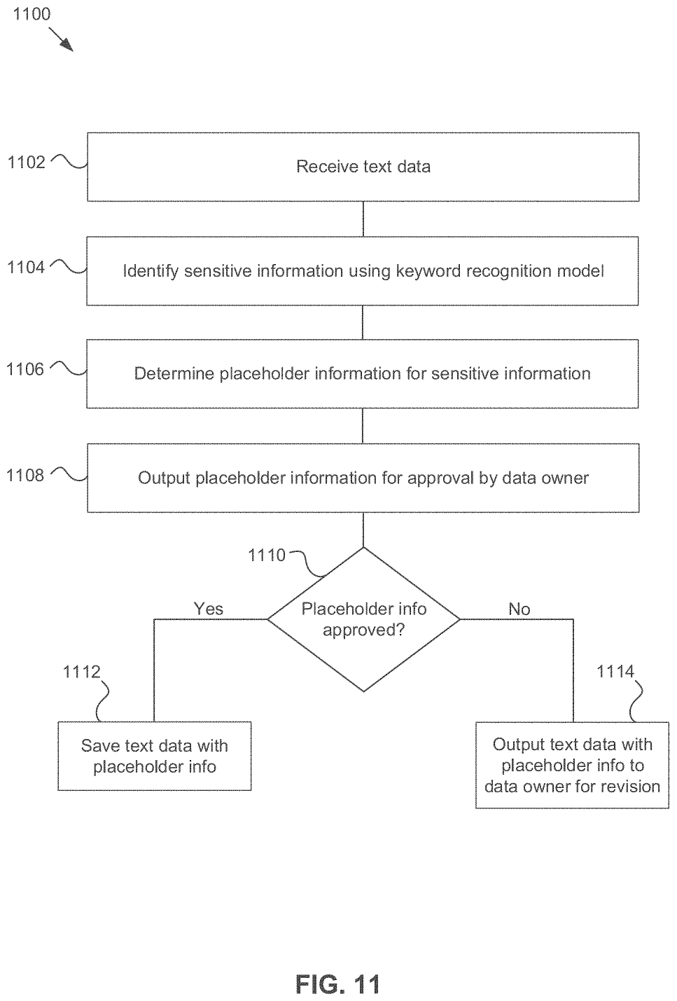

FIG. 11 illustrates a method 1100 of determining the accuracy of placeholder information generated for sensitive information in received data, according to an embodiment. The data recognition model may be implemented after being trained using a training data set. However, data formats and content may include various unpredictable elements not anticipated in the training data set. Accordingly, the model may be continuously updated using feedback from data owners on what does and does not constitute sensitive information.

The method 1100 may include receiving data indicative of sensitive information (block 1102). The data may, for example, be text data, image data, audio data, and so forth. The method 1100 may include identifying, by a data recognition model, sensitive information indicated by the received data (block 1104). The method 1100 may include determining placeholder data for the sensitive information (block 1106).

The method 1100 may include outputting the received data with the placeholder data such that the received data indicates the placeholder information in place of the sensitive information (block 1108). The received data with the placeholder data may be output to a client device and/or application associated with the data owner. The received data with the placeholder data may be output in a first format that is uneditable at a client device and/or application. For example, the received data with the placeholder data may be displayed as static text in a web browser. The received data with the placeholder data may be output in an editable format. For example, the received data may be output in a text input field configured to receive text input from the data owner.

The method 1100 may include determining whether the placeholder information is approved by the data owner (block 1110). For example, approval data may be received that indicates the placeholder information is correct. The method 1100 may include saving the received data with the placeholder data for output upon request by an authorized user (block 1112). Redacted data may be generated that includes the first text data and the placeholder data such that the placeholder information replaces the sensitive information. As another example, rejection data may be received that indicates the placeholder information is incorrect. In various implementations, the rejection data may be received after the data was output in an uneditable format. The method 1100 may include outputting the received data with the placeholder data in a format that is editable at the client device and/or application associated with the data owner (block 1114).

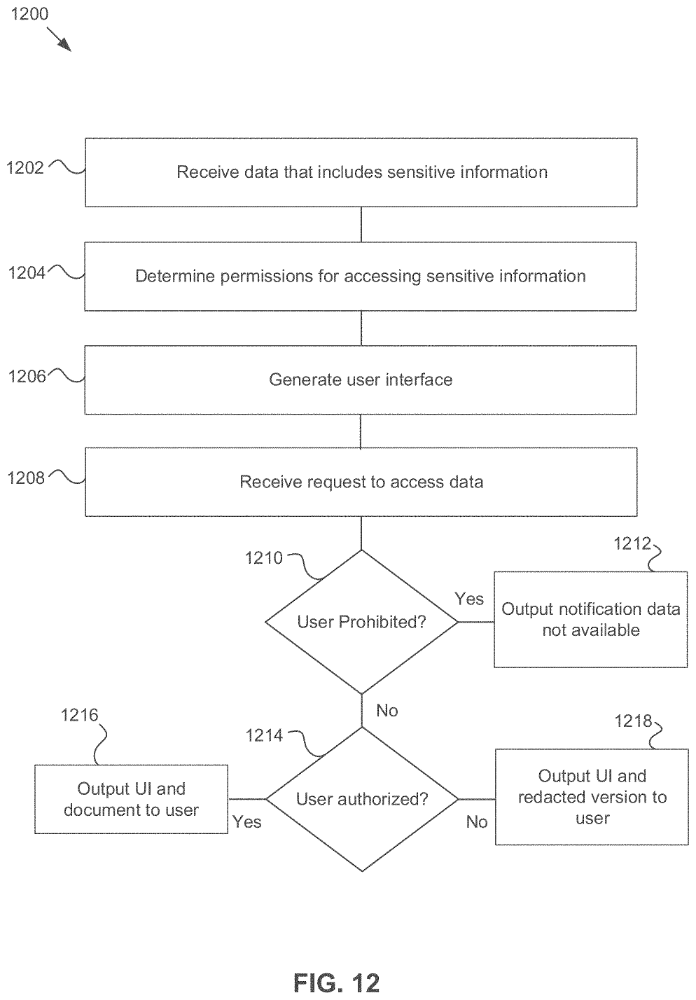

FIG. 12 illustrates a method 1200 of determining an output based on whether a user is explicitly prohibited from accessing requested data, according to an embodiment. In various cases, a user may misuse sensitive information. As a specific example, a user that is subject to a commission contract with a data owner may violate or otherwise breach the contract. The user may be restricted from accessing sensitive information in other data. By automatically and/or expressly restricting certain users from accessing sensitive information, network bandwidth and processing bandwidth may be conserved by reducing back-and-forth traffic related to requests by restricted users.

The method 1200 may include receiving first data that indicates sensitive information (block 1202). The method 1200 may include determining access data corresponding to access permission for the sensitive information (block 1204). The access data may be indicative of permitted users data and/or prohibited users data. The permitted users data may, for example, be a data table of users permitted to access the sensitive information. The prohibited users data may, for example, be a data table of users expressly prohibited from accessing the sensitive information. The method 1200 may include generating a user interface comprising a data field and a corresponding interactable data object (block 1206). The interactable data object may correspond to generating a computer-readable request for the first data. The user interface may be generated as data and/or other computer-readable instructions executable by a client application and/or client device. The data and/or instructions may be output to a client device.

The method 1200 may include receiving request data corresponding to a request for the first data (block 1208). The method 1200 may include determining whether the request data indicates a user that is indicated by the access data as a prohibited user (block 1210). The method 1200 may include, in response to the prohibited users data indicating the requesting user, outputting notification data that indicates the requesting user is prohibited from accessing the first data or the sensitive information indicated by the first data (block 1212).

The method 1200 may include, in response to the requesting user not being indicated in the prohibited users data, determining whether the access data indicates the requesting user is authorized to access the sensitive information (block 1214). Additionally or alternatively, it may be determined whether the requesting user is indicated by the permitted users data. The method 1200 may include, in response to the access data indicating the requesting user, outputting the first data with the sensitive information to the requesting user (block 1216). The user interface may be output with the data field populated with the first data. The method 1200 may include, in response to the access data not indicating the requesting user, outputting a redacted version of the first data (block 1218).

In various implementations, a user may be prohibited from accessing the sensitive information because the user was caught violating a previous agreement on usage of other sensitive information. For example, the sensitive information may relate to identifying information about a job candidate. A recruiter may enter into an agreement to pay a bounty to a candidate finder for placing the job candidate in a job. The agreement may be based on self-reporting to the finder that the recruiter placed the candidate. The recruiter may fail to report and/or pay the agreed-to bounty. A system such as the data redaction system may detect such “cheating” by monitoring various online profiles of the candidate, such as the candidate's LinkedIn® profile and/or other social media profiles. The system may determine the candidate's current or updated employment status indicates the candidate was placed in a position for which the recruiter was recruiting. The system may automatically notify the finder of the breach. The system may automatically revoke sensitive information permissions for the recruiter.

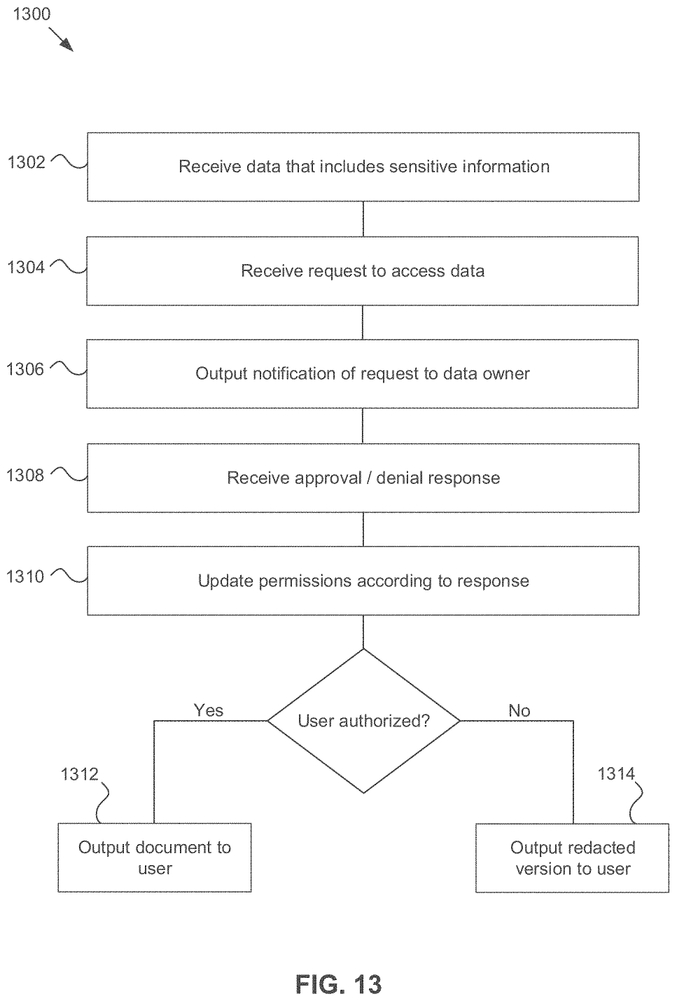

FIG. 13 illustrates a method 1300 of granting permission to view sensitive information in requested data, according to an embodiment. A data owner may wish to control who sees sensitive information in data. When the data is formatted in a document, the conventional solution has been to send the document directly the those with authorization to view the sensitive information. However, the method 1300 enables a data owner to grant authorization directly instead of sending the data. This reduces network traffic and conserves network bandwidth.

The method 1300 may include receiving first data that indicates sensitive information (block 1302). The method 1300 may include receiving request data indicative of a request to view the data and/or the sensitive information (block 1304). The method 1300 may include outputting notification data that indicates access to the data has been requested (block 1306). The notification data may indicate the identity of the user requesting to view the sensitive information. The notification data may be output to the data owner or a data manager associated with the data having the sensitive information.

The method 1300 may include receiving approval data (block 1308). The approval data may indicate permission is granted for the requesting user to view the sensitive information. The approval data may indicate denial of the request to view the sensitive information. The method 1300 may include updating access data for the sensitive information to indicate a permission for the requesting user to view the sensitive information (block 1310). The access data may indicate the requesting user is permitted to view all of the sensitive information. The access data may indicate the requesting user is permitted to view a portion of the sensitive information and restricted from viewing another portion of the sensitive information. The access data may indicate the requesting user is restricted from viewing the sensitive information. The method 1300 may include, in response to the requesting user being permitted to view the sensitive information, outputting the data to a client device and/or application associated with the requesting user (block 1312). The method 1300 may include, in response to the user being restricted from, or not authorized to view the sensitive information, outputting a redacted version of the data (block 1314).

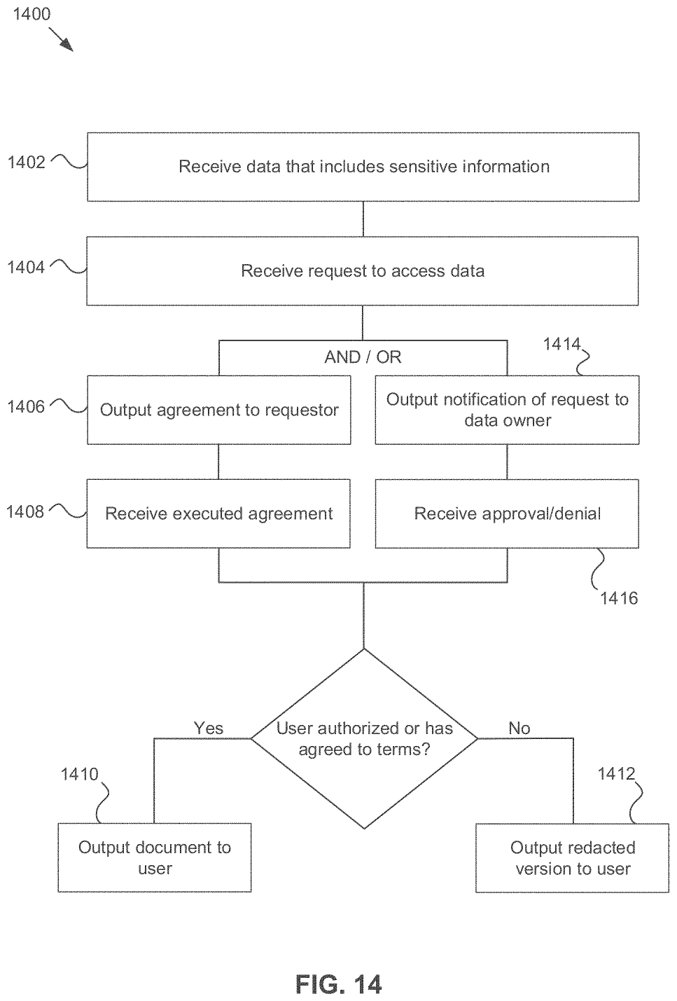

FIG. 14 illustrates a method 1400 of granting permission to view sensitive information in requested data based on various conditions, according to an embodiment. In various cases, a data owner may prefer contracts and/or other agreements be executed by users requesting to view the sensitive data. Conventional solutions may eat up tremendous amounts of network bandwidth with several data transfers between the data owner and the requesting user. This is also costly in the amount of time it takes for an agreement to be executed. The method 1400 addresses these issues by automating the agreement process and mediating between the data owner and the requesting user. Network resources are conserved, and the amount of time taken to execute the agreement is reduced.

The method 1400 may include receiving first data that indicates sensitive information (block 1402). The method 1400 may include receiving request data indicative of a request to view the data and/or the sensitive information (block 1404). The method 1400 may include outputting terms data that indicates a condition associated with gaining access to the sensitive information (block 1406). The terms data may be output automatically in response to receiving the request. The terms data may be output to a client device and/or application associated with a user requesting to view the sensitive information. The terms data may indicate a contract associated with gaining access to the sensitive information. The condition may, for example, be an agreement to pay money to view the sensitive information. In a specific example, the condition may be an agreement to pay a bounty for placing a job candidate indicated by the sensitive information. The condition may be an agreement to pay a commission for filling a job indicated by the sensitive information.

The method 1400 may include receiving agreement data from the client device and/or application (block 1408). The agreement data may indicate the requesting user agrees to the condition associated with gaining access to the sensitive information. The agreement data may indicate the requesting user does not agree to the condition associated with gaining access to the sensitive information. The method 1400 may include, in response to the agreement data indicating the requesting user agrees to the condition indicated in the terms data, outputting the data with the sensitive information to the requesting user (block 1410). The method 1400 may include, in response to the agreement data indicating the requesting user does not agree to the condition indicated by the terms data, outputting a redacted version of the data to the requesting user (block 1412).

The method 1400 may include, additionally or alternatively, outputting notification data to a client device and/or application associated with the data owner (block 1414). The notification data may be output in tandem, although not necessarily simultaneously, with the terms data. The notification data may be output in response to receiving the request to view the sensitive information. The notification data may be output in response to receiving the agreement data. The notification data may be output in response to the agreement data indicating the requesting user agrees to the condition indicated by the terms data. The notification data may be output in response to the agreement data indicating the requesting user does not agree to the condition indicated by the terms data. For example, the notification data may be output to determine whether the data owner agrees to authorize the requesting user when the requesting user has not agreed to the condition.

The method 1400 may include receiving approval data from the data owner (block 1416). The approval data may indicate the requesting user is approved to access the sensitive information. The approval data may indicate the requesting user is not approved, e.g., denied to or restricted from accessing the sensitive information. In response to the approval data indicating the requesting user is approved to view the sensitive information, a full, unredacted version of the data may be output to the requesting user. In response to the approval data indicating the requesting user is not approved to view the sensitive information, a redacted version of the data may be output to the requesting user. Alternatively, in response to the approval data indicating the requesting user is not approved to view the sensitive information, second notification data may be output to the requesting user notifying the requesting user that approval was not granted.

A specific example of the methods, systems, and devices described above may be implemented in the recruiting industry. A recruiting application may be implemented on a server. Various elements of the recruiting application may include web pages that are accessible via web browsers and native applications on client devices. Various elements of the web application may include data, keyword, and/or named entity recognition models. A data owner may upload a full version of a client's resume. The web application may automatically identify sensitive information in the resume, such as the client's name, contact information, the names of previous employers, and so forth. The web application may automatically generate a redacted version of the client's resume.

The redacted version of the client's resume may be generated and posted on a job board web page. Another recruiter may view the redacted version and request, via the job board web page, to view an unredacted version of the resume. An agreement may automatically be displayed to the recruiter. The agreement may indicate a bounty, payable to the data owner, for placing the client in a job. The recruiter may consent to the agreement, such as by inputting a digital signature into a data field in the web page. The unredacted resume may then be displayed in a web page to the recruiter. The unredacted resume may be downloaded to the recruiter's device.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements, and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

1. A system, comprising:
one or more processing devices; and
one or more memory devices in communication with the one or more processing devices, the one or more memory devices storing computer program instructions executable by the one or more processing devices to:
receive, from a first client device, first document data corresponding to a first document, wherein the first document comprises sensitive information;
receive, from the first client device, redaction data corresponding to redaction of the sensitive information;
determine access data that indicates one or more permissions to access the sensitive information;
receive, from a second client device, request data corresponding to a request for the first document, wherein the request data comprises individual user data that indicates an individual user requesting access to the first document;
determine, based on the individual user data, whether the access data indicates permission for the individual user to access the sensitive information;
in response to the access data indicating permission for the individual user to access the sensitive information, output, to the second client device, the first document data;
in response to the access data not indicating permission for the individual user to view the sensitive information, output, to the second client device, second document data that corresponds to the first document with the sensitive information redacted, wherein:
the second document data is generated based on the first document data and the redaction data in response to:
receiving the redaction data and the first document data; or
determining the access data does not indicate permission for the individual user to view the sensitive information; or
the second document data is received from the first client device and comprises the redaction data.

2. The system of claim 1, wherein outputting the first document data or the second document data comprises:
generating, for display at the second client device, a user interface comprising a data field populated with:
the first document data or the second document data;
image data based on the first document data or the second document data; or
hyperlink data that indicates a uniform resource location for the first document data or the second document data; or
generating message data that is output to the second client device via a mail server, the message data comprising:
the first document data or the second document data;
the image data; or
the hyperlink data.

3. The system of claim 1, wherein, to determine the access data, the computer program instructions are further executable to generate the access data in response to receiving the first document data, wherein the access data indicates a user that uploaded the first document.

4. The system of claim 1, wherein the access data comprises permitted users data and prohibited users data, the computer program instructions further executable to:
in response to receiving the request data, determine the individual user is indicated by the prohibited users data; and
in response to the prohibited users data indicating the individual user, output, to the second client device, notification data that indicates the individual user is prohibited from accessing:
the first document; or
the sensitive information.

5. The system of claim 1, the computer program instructions further executable to:
output, to the first client device, notification data that indicates the individual user has requested access to the first document;
receive, from the first client device, approval data that indicates the individual user is permitted to access the first document; and
update the access data to indicate the individual user is permitted to access the first document.

6. The system of claim 1, the computer program instructions further executable to generate, for display at the first client device, a user interface comprising:
a document visualization field;
a first interactable data object, wherein a first interaction in the user interface with the first interactable data object triggers receiving the first document data;
a second interactable data object, wherein a second interaction in the user interface with the second interactable data object triggers receiving the redaction data; and
a variable data object, wherein:
a first state of the variable data object corresponds to the document visualization field being populated with first display data corresponding to the first document; and
a second state of the variable data object corresponds to the document visualization field being populated with second display data corresponding to the redaction data.

7. The system of claim 1, the computer program instructions further executable to identify the sensitive information using a data recognition model trained using resume data to identify a candidate name, candidate contact information, a school name, or a company name.

8. A system, comprising:
one or more processing devices; and
one or more memory devices in communication with the one or more processing devices, the one or more memory devices storing computer program instructions executable by the one or more processing devices to:
receive, from a first client device, first text data;
identify, using a keyword recognition model, a portion of the first text data indicating sensitive information;
determine placeholder data for the sensitive information indicated in the first text data, wherein the placeholder data corresponds to placeholder information for replacing the sensitive information;
determine access data corresponding to access permission for the sensitive information;
receive, from a second client device, request data corresponding to a request for the first text data;
determine whether the request data indicates a user that is also indicated by the access data;
in response to the access data indicating the user, output the first text data to the second client device; and
in response to the access data not indicating the user, output, to the second client device, the first text data with the placeholder data such that the first text data indicates the placeholder information instead of the sensitive information.

9. The system of claim 8, wherein, to identify the portion of the first text data indicating the sensitive information, the computer program instructions are further executable to identify, based on the keyword recognition model, a proper noun indicated by the first text data.

10. The system of claim 8, wherein, to determine the placeholder data, the computer program instructions are further executable to:
receive the placeholder data from the first client device; or
automatically retrieve the placeholder data from a database based on profile data associated with the first client device.

11. The system of claim 8, wherein the keyword recognition model is trained to identify the sensitive information based on:
position data that indicates a position of the sensitive information in a document corresponding to the first text data;
size data that indicates a relative text size associated with the sensitive information, wherein the relative text size is based on various text sizes associated with the first text data;
emphasis data that indicates a text emphasis associated with the sensitive information; or
capitalization data that indicates a capitalization associated with the sensitive information.

12. The system of claim 8, wherein:
the sensitive information comprises entity name information; and
the keyword recognition model comprises a named entity recognition model.

13. The system of claim 8, the computer program instructions further executable to:
output, to the first client device, the first text data with the placeholder data such that the first text data indicates the placeholder information instead of the sensitive information, wherein the first text data with the placeholder data is output in a first format that is uneditable at the first client device;
receive, from the first client device, rejection data that indicates the placeholder information is incorrect;
generate second text data comprising the first text data and the placeholder data such that the second text data indicates the placeholder information instead of the sensitive information; and
output the second text data to the first client device, wherein the second text data is output in a second format that is editable at the first client device.

14. The system of claim 8, the computer program instructions further executable to:
output, to the second client device, terms data that indicates a condition associated with gaining access to the sensitive information;
receive:
agreement data from the second client device, wherein the agreement data indicates the user agrees to the condition associated with gaining access to the sensitive information; or
approval data from the first client device, wherein the approval data indicates the user is approved to access the sensitive information; and
in response to receiving the agreement data or the approval data, update the access data to indicate the user.

15. A system, comprising:
one or more processing devices; and
one or more memory devices in communication with the one or more processing devices, the one or more memory devices storing computer program instructions executable by the one or more processing devices to:
receive, from a first client device, first data that indicates sensitive information;
determine access data corresponding to access permission for the sensitive information;
receive, from a second client device, request data corresponding to a request for the first data;
determine whether the request data indicates a user that is also indicated by the access data;
in response to the access data indicating the user, output the first data to the second client device; and
in response to the access data not indicating the user, output, to the second client device, second data that corresponds to the first data with the sensitive information redacted.

16. The system of claim 15, the computer program instructions further executable to:
identify the sensitive information in the first data using a data recognition model trained to identify the sensitive information; and
in response to identifying the sensitive information, generate the second data.

17. The system of claim 15, wherein the first data is obtained from a third-party server or database device by an application configured to search the third-party server or database device for the first data.

18. The system of claim 15, the computer program instructions further executable to:
generate the second data; and
update the second data to indicate alternative information instead of the sensitive information.

19. The system of claim 15, the computer program instructions further to:
generate a user interface comprising a data field and a corresponding interactable data object, wherein:
the data field is populated with the second data; and
receiving the request data corresponds to an interaction with the interactable data object in the user interface; and
in response to the access data indicating the user associated with the request data, updating the data field to be populated with the first data that indicates the sensitive information.

20. The system of claim 15, the computer program instructions further to:
receive restriction data that indicates the first data is indicative of the sensitive information, wherein determining the access data is in response to receiving the restriction data; and
in response to receiving the request data before receiving the restriction data, output, to the second client device, the first data.
